(19) United States
(12) Patent Application Publication
(10) Pub. No.: US 2010/0153275 A1
(43) Pub. Date: Jun. 17, 2010

(54) METHOD AND APPARATUS FOR THROTTLING ACCESS USING SMALL PAYMENTS

(75) Inventors: Bjorn Markus Jakobsson, Mountain View, CA (US); Christopher Soghoian, Somerville, MA (US)

Correspondence Address: PVF -- PARC;c/o PARK, VAUGHAN & FLEMING LLP, 2820 FIFTH STREET, DAVIS, CA, 95618-7759, US

(73) Assignee: PALO ALTO RESEARCH CENTER INCORPORATED, Palo Alto, CA (US)

(21) Appl. No.: 12/336,004

(22) Filed: Dec. 16, 2008

(51) Int. Cl. G06Q 20/00; H04L 9/00

(52) U.S. Cl. 705/71; 705/39

(57) ABSTRACT

One embodiment of the present invention provides a system for controlling access to resources using small payments. The system receives a request from an entity to access a resource. In response, the system requests the entity to submit information about the entity's account with a financial service provider (FSP). The system then transfers a fund to the entity's account and sends a message through the FSP to the entity with the fund transfer. The system receives from the entity an input corresponding to the message and determines that a first condition is met based on the received input and the message. As a result, the system grants the entity access to the resource.

### BACKGROUND

1. Field

The present disclosure relates to a method for access control. More specifically, the present disclosure relates to a method for access control using small payments.

2. Related Art

Many web service providers face the challenge of access control, which prevents people or organizations from abusing the web service's resources. For example, a service that provides webmail access, such as Hotmail™, Gmail™, and Yahoo!™ mail, needs to prevent malicious users (often email spammers) from using automated software to register large number of accounts. Online posting sites, such as blogs, forums, and wikis, need to prevent malicious users from using automated software, often referred to as robots or “bots,” to submit posts for purposes of commercial promotion or harassment. In addition, websites that provide commercial services, such as eBay™ and Ticketmaster™, need to prevent malicious users from using automated software to exhaust available connections thus blocking access by legitimate users.

To prevent the use of an automated response which may exhaust resources, many websites require a user to perform a CAPTCHA (Completely Automated Public Turing test to tell Computers and Humans Apart) test before establishing an account or accessing the website's resources. A CAPTCHA test is a visual or audio challenge that can only be accurately solved by humans. Examples of CAPTCHA tests include distorted text or text with additional lines; both are difficult for OCR (optical character recognition) software to recognize.

However, the use of CAPTCHAs has several drawbacks. First, since the emergence of CAPTCHAs, there have been attempts to develop better pattern recognition software that is able to read CAPTCHAs, and many CAPTCHAs are now machine-solvable. Second, some CAPTCHAs are too difficult for users to solve and require further human intervention. Third, CAPTCHAs are vulnerable to relay attacks that use humans to solve the puzzles. For example, some spammers have been known to hire hundreds of workers to solve CAPTCHAs in order to gain access to free web emails. Therefore, the mere use of CAPTCHAs does not guarantee an access control that can prevent malicious users from exhausting the resources and can ensure legitimate users fair chances for accessing the resources. What is needed is an access control scheme that is both user-friendly and resistant to massive parallelization by means of automation or outsourcing.

### SUMMARY

One embodiment of the present invention provides a system for controlling access to resources using small payments. The system receives a request from an entity to access a resource. In response, the system requests the entity to submit information about the entity's account with a financial service provider (FSP). The system then transfers a fund to the entity's account and sends a message through the FSP to the entity with the fund transfer. The system receives from the entity an input corresponding to the message and determines that a first condition is met based on the received input and the message. As a result, the system grants the entity access to the resource. This type of access control can be used to bootstrap other, later access requests.

In a variation on this embodiment, the message includes a cryptographic key that can be an authentication key or an encryption key.

In a further variation, the input includes a message processed with the cryptographic key.

In a variation on this embodiment, the message includes a randomly generated alphanumeric string.

In a variation on this embodiment, the system further determines that a second condition is met based on the entity's account with the FSP. This condition may be that the account is with a bank in a certain country, or of a certain type. This configuration helps the system determine that the request is of a certain type. It can also facilitate identification of access requests associated with small FSPs that can potentially be under the control of a believed attacker.

In a variation on this embodiment, the resource access granted to the entity can be used to facilitate a future resource-access attempt from the entity.

### BRIEF DESCRIPTION OF THE FIGURES

FIG. 1 illustrates an exemplary computing environment for access control using small payments in accordance with one embodiment of the present invention.

FIG. 2 illustrates a block diagram for an access-control server in accordance with one embodiment of the present invention.

FIG. 3 presents a flowchart illustrating the process of access control using small payments in accordance with one embodiment of the present invention.

FIG. 4 illustrates an exemplary computer system for access control using small payments in accordance with one embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

Embodiments of the present invention provide a system for controlling access to a resource to prevent automated bot access without the use of CAPTCHAs. In one embodiment, the access control system acquires a users' account information associated with a financial service provider (FSP) and sends a small payment along with a message to the user's financial-service account. Subsequently, the user is presented with a challenge based on the payment and the message. By comparing the user's response with the earlier-sent payment amount and message, the system is able to verify that the user requesting the resource access is a legitimate entity, e.g., a human being instead of an automated program.

In a conventional CAPTCHA-based access control system, the system is prone to repeated guesses by an automated program, because a user usually have unlimited or a large number of CAPTCHA trials. As a result, as long as the number of guesses is sufficiently large, an attacker can obtain a large number of accesses to the online resource, such as free email accounts. In the present embodiments, the system can significantly reduce the number of successful attacker guesses by challenging a user to provide information that has been transmitted to his financial-service account. Because a typical user only has a small number of accounts, it would be very difficult for an automated program to perform a large number of guesses corresponding to different user accounts.

Embodiments of the invention utilize the fact that most financial service providers, such as commercial banks and credit card issuers, require a user to provide and verify personal identity information before opening an account. Such identity information can ensure that the owner of the account is a real person instead of an automated software process. Because commercial banks and credit card issuers often verify a user's identity through reliable information, such as his Social Security number (SSN), it is very unlikely for a user to obtain a large number of accounts from one financial service provider. Other financial service providers, such as PayPal™ and online stock-trade-brokerage services, often require an initial deposit or a link to the user's bank account, thus also preventing a user from obtaining a large number of accounts. By linking a user's access to an online resource to his FSP account, embodiments of the present invention can effectively limit the number of accesses a user can obtain and hence prevent abusive usage of online resources.

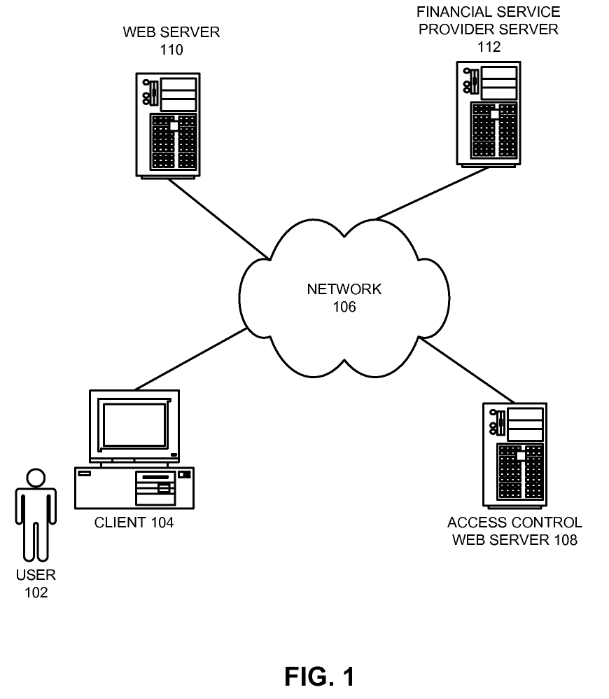

FIG. 1 illustrates an exemplary computing environment for access control using small payments in accordance with one embodiment of the present invention. In this environment, a user 102 is coupled to a network 106 via a client 104. An access control server 108 provides access control to online resources, such as web services, stored on a web server 110. A financial service provider (FSP) server 112 provides online access to an FSP.

User 102 may correspond to: an individual, a group of individuals, an organization, a group of organizations, a computing system, a group of computing systems, or any other entity that can access client 104.

Client 104 may represent nodes on network 106 with computational capability and mechanisms for communicating across the network. For example, client 104 may correspond to personal computers (PCs), laptop computers, workstations, and/or other electronic computing devices with network connectivity. Furthermore, clients 104 may connect to network 106 using one or more wired and/or wireless connections.

Access-control server 108 may correspond to nodes on a network that include functionality to service requests from client 104 for resource access. For example, access-control server 108 may receive and grant user 102's request for accessing a resource. The resource may be located on access-control server 108 or on a web server 110 which provides web services to user 102. Access-control server 108 and web server 110 may participate in an advanced computing cluster, or can act as stand-alone servers.

Network 106 may correspond to any type of wired or wireless communication channels capable of coupling together computing nodes (e.g., client 104, access-control web 108, web server 110, and FSP server 112). This includes, but is not limited to, a local area network (LAN), a wide area network (WAN), and/or a combination of networks. In one or more embodiments of the present invention, network 106 includes the Internet. Network 106 may also include phone and cellular phone networks, such as Global Systems for Mobile communications (GSM) networks.

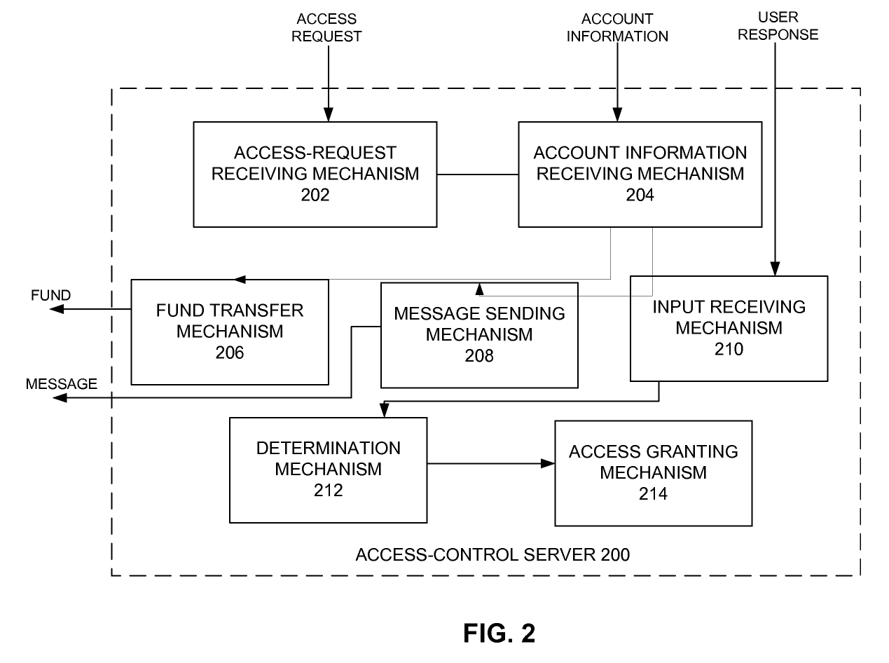

FIG. 2 illustrates a block diagram for an access-control server in accordance with one embodiment of the present invention. In one embodiment, access-control server 200 includes an access-request receiving mechanism 202, an account information receiving mechanism 204, a fund transfer mechanism 206, a message sending mechanism 208, an input receiving mechanism 210, a determination mechanism 212, and an access granting mechanism 214.

During operation, access-request receiving mechanism 202 receives from a user a request for access to the online resource. Account information receiving mechanism 204 then requests and receives the financial-service account information from the user. In one embodiment, the financial-service account information can include a bank's identifier (such as the American Bankers Association (ABA) routing number) and an account number. Subsequently, fund transfer mechanism 206 transfers a small amount of fund to the user's account. For example, fund transfer mechanism 206 can transfer two cents to the requesting user's account. In some embodiments, the fun transfer mechanism 206 can transfer a fixed, small amount, such as one cent, to the user's account to minimize costs. In addition, since most financial services allow a message to be sent with a fund transfer, message sending mechanism 208 sends a message along with the fund. In one embodiment, this message can be a random alphanumeric string that is sufficiently robust against any dictionary attack. Note that this message can significantly increase the robustness of the system, because a malicious user might be able to guess the amount of the transferred fund. However, it would be much more difficult to guess both the transferred amount and the message.

Subsequently, access-control server 200 may request the user to input a response based on the transferred fund and the accompanying message. For example, the user may receive an email from the access-control server 200 notifying the user to click on a link which leads to a web page that asks for the transferred amount and the accompanying message. In response, input receiving mechanism 210 receives an input from the user. Determination mechanism 212 then determines whether the user input is consistent with the transferred amount and the message. If the user input matches the transferred amount and previously sent message, and access granting mechanism 214 grants the user access to the online resource. Otherwise, the user is denied access.

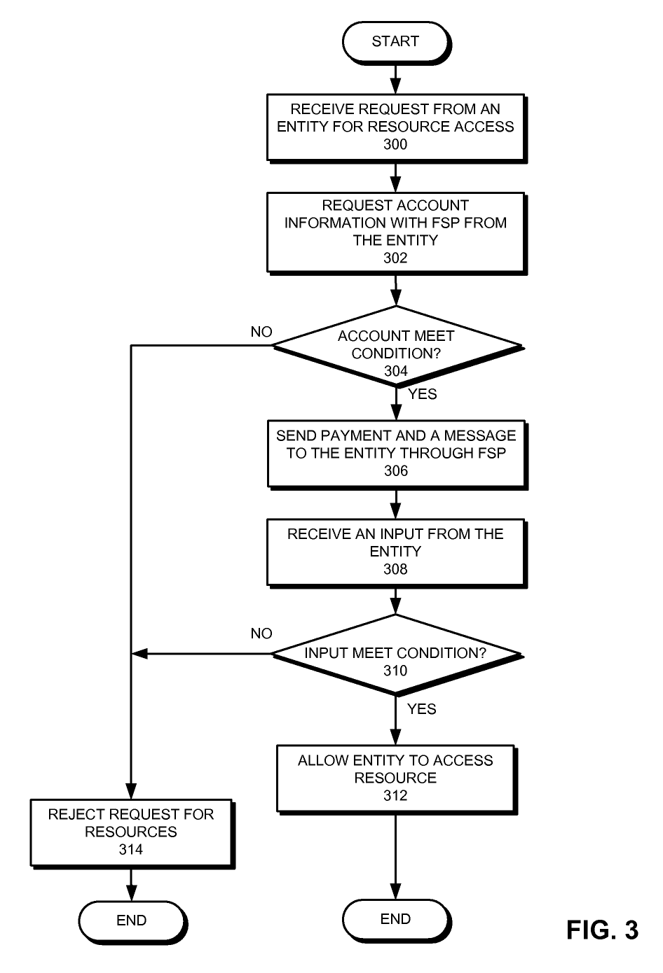

FIG. 3 presents a flowchart illustrating the process of access control using small payments in accordance with one embodiment of the present invention. In one embodiment, access-control server 108 first receives a request from an entity to access a resource (operation 200). The entity can be but is not limited to user 102 using client 104 or a proxy for user 102. The resource can be but is not limited to an online service provided by access-control server 108, an online service provided by web server 110, or other physical resources such as entrance to a building or room. In response, access-control server 108 requests the entity to provide information about an account from an FSP (operation 302). The account can be, but is not limited to: a bank account, a credit card account, a PayPal™ account, or a stock-trade-brokerage account.

After receiving the account information, access-control server 108 determines if the account meets certain conditions (operation 304). For example, access-control server 108 may check whether the FSP account is a valid account with a known or trustworthy FSP, or whether the account has been used before to gain resource access. In one embodiment, access-control server 108 grants up to a predetermined number of requests to users that are associated with an FSP account. Access-control server 108 can also control access based on the properties of the FSP account. In one embodiment, access-control server 108 uses the geographic locations of the FSP to control access. For example, server 108 may grant only up to a predetermined number of access requests to users located in the United States (US). Thus, a user providing a US bank account cannot gain access once server 108 determines that the number of requests using US FSP accounts has exceeded a threshold. Other account properties include but are not limited to the type of account and the FSP the account belongs to. The requirement that the FSP account meets certain condition also helps avoid access requests associated with small-unknown FSPs that may potentially be under the control of a believed attacker.

If access-control server 108 determines that the FSP account fails to meet predetermined conditions, server 108 rejects the request for resource access (operation 314). Otherwise, server 108 sends a small payment along with a message, in the form of a memo or other type of user message, to the FSP account (operation 306). Server 108 can send the payment using standard fund transferring techniques, such as wire transfer. In one embodiment, the server uses a proxy, such as the server's banking institution, to transfer the fund. The payment amount can be a randomly generated small number, such as a random amount ranging from 1 cent to 99 cents. In one embodiment, server 108 sends 1 cent to minimize cost. As described above, the message can be a randomly generated alphanumeric string to prevent a third party from predicting the message. In one embodiment, the message can include a cryptographic key, such as an authentication key or an encryption key. The user can use the encryption key to generate an encrypted message of pre-agreed data, such as the date of the transaction.

Subsequent to receiving the payment on his FSP account along with the message, the user can send an input to access-control server 108 (operation 308). The user can obtain the payment information and message from FSP server 112. In addition, the FSP may notify the user of payment information and message using other techniques, such as email. The user's input can include information about the payment amount and the message. For example, the user's input may include a read back of the message. In the case where the message includes an encryption key, the user's input includes an encrypted message using the encryption key.

Access-control server 108 then determines if the user's input meets certain conditions (operation 310). For example, server 108 determines whether the payment amount reported by the user matches the amount sent by server 108. Server 108 can also determine whether the user correctly repeats the server-sent message. Or, when encryption is used, access-control server 108 first decrypts the user's input using the same encryption key, and then determines if the decrypted message, such as the date of the transaction, matches a record on server 108. In addition, the condition can be associated with a time interval, or can be associated with any policy in the context of environmental data acquired by the time the determination is made. By showing knowledge about the payment amount and message, the user proves to access-control server 108 his ownership of the FSP account. If access-control server 108 determines that the user's input meets the predetermined conditions, server 108 grants the user's request for resource access (operation 312). Otherwise, access-control server 108 rejects the request for resource access (operation 314).

Note that once the resource access is granted to an entity, access-control server 108 may not need to perform a similar process in the future. Instead, the granted resource access can be used to bootstrap other, later access request from the same entity. For example, once an entity is granted resource access, the entity can be given a user ID and a password. Later, when the entity is requesting to access resource again, instead of providing FSP account information, the entity can simply use the user ID and the password to gain access to the resource.

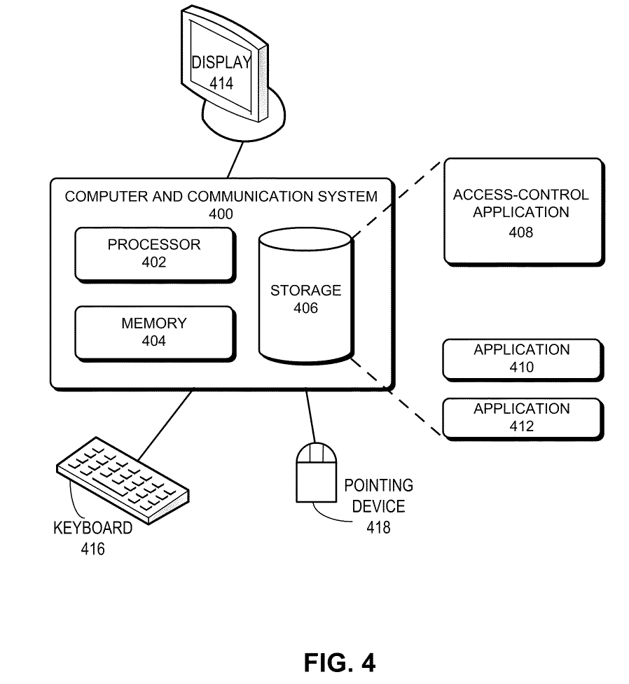

FIG. 4 illustrates an exemplary computer system for controlling resource access in accordance with one embodiment of the present invention. In one embodiment, a computer and communication system 400 includes a processor 402, a memory 404, and a storage device 406. Storage device 406 stores an access-control application 408, as well as other applications, such as applications 410 and 412. During operation, access-control application 408 is loaded from storage device 406 into memory 404 and then executed by processor 402. While executing the program, processor 402 performs the aforementioned functions. Computer and communication system 400 is coupled to an optional display 414, keyboard 416, and pointing device 418.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

The data structures and code described in this detailed description are typically stored on a computer-readable storage medium, which may be any device or medium that can store code and/or data for use by a computer system. This includes, but is not limited to, volatile memory, non-volatile memory, application-specific integrated circuits (ASICs), field-programmable gate arrays (FPGAs), magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

What is claimed is:

1. A method for controlling access to a resource, comprising:
receiving a request from an entity to access the resource;
requesting information about the entity's account with a financial service provider (FSP);
transferring a fund to the entity's account;
sending a message through the FSP to the entity with the fund transfer;
receiving from the entity an input corresponding to the message;
determining that a first condition is met based on the received input and the message; and
granting the entity access to the resource.

2. The method of claim 1, wherein the message includes a cryptographic key that can be an authentication key or an encryption key.

3. The method of claim 2, wherein the input includes a message processed with the cryptographic key.

4. The method of claim 1, wherein the message includes a randomly generated alphanumeric string.

5. The method of claim 1, further comprising determining that a second condition is met based on the entity's account with the FSP.

6. The method of claim 1, wherein the resource access granted to the entity can be used to facilitate a future resource-access attempt from the entity.

7. A computer-readable storage medium storing instructions which when executed by a computer cause the computer to perform a method for controlling access to resources, the method comprising:
receiving a request from an entity to access the resource;
requesting information about an entity's account with a financial service provider (FSP);
transferring a fund to the entity's account;
sending a message through the FSP to the entity with the fund transfer;
receiving from the entity an input corresponding to the message;
determining that a first condition is met based on the received input and the message; and
granting the entity access to the resource.

8. The computer-readable storage medium of claim 7, wherein the message includes a cryptographic key that can be an authentication key or an encryption key.

9. The computer-readable storage medium of claim 8, wherein the input includes a message processed with the cryptographic key.

10. The computer-readable storage medium of claim 7, wherein the message includes a randomly generated alphanumeric string.

11. The computer-readable storage medium of claim 7, wherein the method further comprises determining that a second condition is met based on the entity's account with the FSP.

12. The computer-readable storage medium of claim 7, wherein the resource access granted to the entity can be used to facilitate a future resource-access attempt from the entity

13. A computer system for controlling access to a resource, comprising:
a processor;
a memory;
an access-request receiving mechanism configured to receive a request from an entity for access to the resource;
an account-information receiving mechanism configured to receive information about the entity's account with a financial service provider (FSP);
a transfer mechanism configured to transfer a fund to the entity's account;
a sending mechanism configured to send a message through the FSP to the entity with the fund transfer;
an input-receiving mechanism configured to receive from the entity an input corresponding to the message;
a determination mechanism configured to determine that a first condition is met based on the received input and the message; and
a granting mechanism configured to grant the entity access to the resource.

14. The computer system of claim 13, wherein the message includes a cryptographic key that can be an authentication key or an encryption key.

15. The computer system of claim 14, wherein the input includes a message processed with the cryptographic key.

16. The computer system of claim 13, wherein the message includes a randomly generated alphanumeric string.

17. The computer system of claim 13, further comprising a mechanism configured to determine that a second condition is met based on the entity's account with the FSP.

18. The computer system of claim 13, wherein the resource access granted to the entity can be used to facilitate a future resource-access attempt from the entity
